(19) United States
(12) Patent Application Publication
(10) Pub. No.: US 2025/0106371 A1
(43) Pub. Date: Mar. 27, 2025

(54) Systems and methods of multi-view stereo reconstruction using ultra wideband (UWB) communication

(71) Applicant: GOOGLE LLC, Mountain View, CA (US)

(72) Inventor: Dongeek Shin, Mountain View, CA (US)

(21) Appl. No.: 18/574,501

(22) PCT Filed: Mar. 8, 2023
(86) PCT No.: PCT/US2023/014810

§ 371 Date: Dec. 27, 2023

(51) Int. Cl. H04N 13/156; H04B 1/7163; H04N 13/243

(52) U.S. Cl. CPC H04N 13/156; H04B 1/71632; H04N 13/243; H04B 2201/71634

(57) ABSTRACT

Systems and methods for multi-view stereo reconstruction using ultra wideband (UWB) communication are provided. Example techniques may include receiving a first two-dimensional image of a three-dimensional object captured by a first device, receiving a second two-dimensional image of the three-dimensional object captured by a second device, receiving an indication of timing and directionality associated with UWB signals exchanged between the first device and the second device, determining relative positions and relative poses of the first device and the second device with respect to one another based on the indication of the timing and directionality associated with the UWB signals exchanged between the first device and the second device, and generating a three-dimensional image of the three-dimensional object based on the first two-dimensional image, the second two-dimensional image, and the relative positions and relative poses of the first device and the second device with respect to one another.

### FIELD OF THE INVENTION

The present disclosure generally relates to technologies associated with multi-view stereo reconstruction, and more particularly, to technologies for multi-view stereo reconstruction using ultra wideband (UWB) communication.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally speaking, multi-view stereo techniques may be used to construct a three-dimensional image of an object based on multiple two-dimensional images of the object captured from different perspectives. Conventionally, the three-dimensional image may be generated by identifying features of the object that are shown in multiple two-dimensional images and “stitching” those two-dimensional images together. If the locations of the cameras that capture the two-dimensional images are fixed or otherwise known, the cameras' positions with respect to one another can inform the way that the two-dimensional images are stitched together to create the three-dimensional image.

However, when the images are captured by cameras of mobile computing devices, such as smart phones, the locations associated with the cameras are not fixed. While GPS techniques can provide a rough estimate of a mobile computing device's location (e.g., within about 3 meters), errors in the estimation of the positions of the mobile computing devices can cause errors in the reconstructed three-dimensional image. Currently, when a three-dimensional image is reconstructed using images captured by mobile computing devices, an initial reconstruction is generated based on the images and the estimated positions of the mobile computing devices, then errors in the initial reconstruction are identified and used to attempt to correct the positions of the mobile computing devices, and a new three-dimensional image is reconstructed based on the corrected positions. This process must then be repeated several times until a suitable three-dimensional image can be generated. This repeated process of error correction and reconstruction becomes especially difficult when there are features present in one image but not another due to real-life image artefacts, such as occlusions, image saturation, etc.

### SUMMARY

In one aspect, a computer-implemented method for multi-view stereo reconstruction using ultra wideband (UWB) communication is provided. The method may include receiving, by one or more processors, a first two-dimensional image of a three-dimensional object captured by a first mobile computing device; receiving, by the one or more processors, a second two-dimensional image of the three-dimensional object captured by a second mobile computing device; receiving, by one or more processors, an indication of timing and directionality associated with UWB signals exchanged between the first mobile computing device and the second mobile computing device; determining, by the one or more processors, relative positions and relative poses of the first mobile computing device and the second mobile computing device with respect to one another based on the indication of the timing and directionality associated with the UWB signals exchanged between the first mobile computing device and the second mobile computing device; and generating, by the one or more processors, a three-dimensional image of the three-dimensional object based on the first two-dimensional image, the second two-dimensional image, and the relative positions and relative poses of the first mobile computing device and the second mobile computing device with respect to one another. The method may include additional, less, or alternate actions, including those discussed elsewhere herein.

In another aspect, a computer system for multi-view stereo reconstruction using ultra wideband (UWB) communication is provided. The computer system may include one or more processors and a memory storing computer-executable instructions that, when executed by the one or more processors, cause the one or more processors to: receive a first two-dimensional image of a three-dimensional object captured by a first mobile computing device; receive a second two-dimensional image of the three-dimensional object captured by a second mobile computing device; receive an indication of timing and directionality associated with ultra UWB signals exchanged between the first mobile computing device and the second mobile computing device; determine relative positions and relative poses of the first mobile computing device and the second mobile computing device with respect to one another based on the indication of the timing and directionality associated with the UWB signals exchanged between the first mobile computing device and the second mobile computing device; and generate a three-dimensional image of the three-dimensional object based on the first two-dimensional image, the second two-dimensional image, and the relative positions and relative poses of the first mobile computing device and the second mobile computing device with respect to one another. The system may include additional, less, or alternate functionality, including that discussed elsewhere herein.

In still another aspect, a computer-readable storage medium, which may be non-transitory, storing computer-readable instructions for multi-view stereo reconstruction using ultra wideband (UWB) communication is provided. The computer-readable instructions, when executed by one or more processors, cause the one or more processors to: receive a first two-dimensional image of a three-dimensional object captured by a first mobile computing device; receive a second two-dimensional image of the three-dimensional object captured by a second mobile computing device; receive an indication of timing and directionality associated with UWB signals exchanged between the first mobile computing device and the second mobile computing device; determine relative positions and relative poses of the first mobile computing device and the second mobile computing device with respect to one another based on the indication of the timing and directionality associated with the UWB signals exchanged between the first mobile computing device and the second mobile computing device; and generate a three-dimensional image of the three-dimensional object based on the first two-dimensional image, the second two-dimensional image, and the relative positions and relative poses of the first mobile computing device and the second mobile computing device with respect to one another. The instructions may direct additional, less, or alternative functionality, including that discussed elsewhere herein.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof.

There are shown in the drawings arrangements which are presently discussed, it being understood, however, that the present embodiments are not limited to the precise arrangements and instrumentalities shown, wherein:

FIG. 1 depicts an exemplary computer system for multi-view stereo reconstruction using ultra wideband (UWB) communication, according to one embodiment;

FIG. 2 illustrates an example “handshake” of UWB between two mobile computing devices, according to one embodiment;

FIG. 3A depicts camera positions and directions with respect to a three-dimensional object, as may be estimated and re-estimated using conventional multi-view stereo reconstruction methods, compared to the actual camera positions and directions with respect to the three-dimensional object;

FIG. 3B depicts example camera positions and directions with respect to a three-dimensional object, as may be calculated accurately using UWB communication between the devices associated with the cameras, according to one embodiment; and

FIG. 4 depicts a flow diagram of an exemplary computer-implemented method for multi-view stereo reconstruction using UWB communication, according to one embodiment.

While the systems and methods disclosed herein is susceptible of being embodied in many different forms, it is shown in the drawings and will be described herein in detail specific exemplary embodiments thereof, with the understanding that the present disclosure is to be considered as an exemplification of the principles of the systems and methods disclosed herein and is not intended to limit the systems and methods disclosed herein to the specific embodiments illustrated. In this respect, before explaining at least one embodiment consistent with the present systems and methods disclosed herein in detail, it is to be understood that the systems and methods disclosed herein is not limited in its application to the details of construction and to the arrangements of components set forth above and below, illustrated in the drawings, or as described in the examples.

Methods and apparatuses consistent with the systems and methods disclosed herein are capable of other embodiments and of being practiced and carried out in various ways. Also, it is to be understood that the phraseology and terminology employed herein, as well as the abstract included below, are for the purposes of description and should not be regarded as limiting.

### DETAILED DESCRIPTION

### Overview

The present disclosure provide techniques for generating a three-dimensional image based on two-dimensional images captured by mobile computing devices and communications between the mobile computing devices using a radio technology that is suitable for short-range, high-bandwidth communications over a large portion of a radio spectrum. One such non-limiting radio technology is ultra-wideband (UWB). For example, when the mobile computing devices capture the two-dimensional images of the object (i.e., as the image is being captured, or shortly thereafter), each of multiple mobile computing devices may send “handshake” signals (e.g., via UWB) to one another, and the round trip time for the “handshake” signals may be used to determine the absolute distances between each of the devices when the images were captured. The angle of arrival of the “handshake” signals may be used to determine the poses of each of the devices, relative to one another, when the images were captured. The three-dimensional image may then be reconstructed using the two-dimensional images, the absolute distances between each of the cameras, and the relative poses of each of the cameras with respect to one another. Advantageously, when the absolute distances between the cameras, and their relative poses with respect to one another, are known, there is no need to repeat this process multiple times in order to generate a suitable three-dimensional image.

### Example System

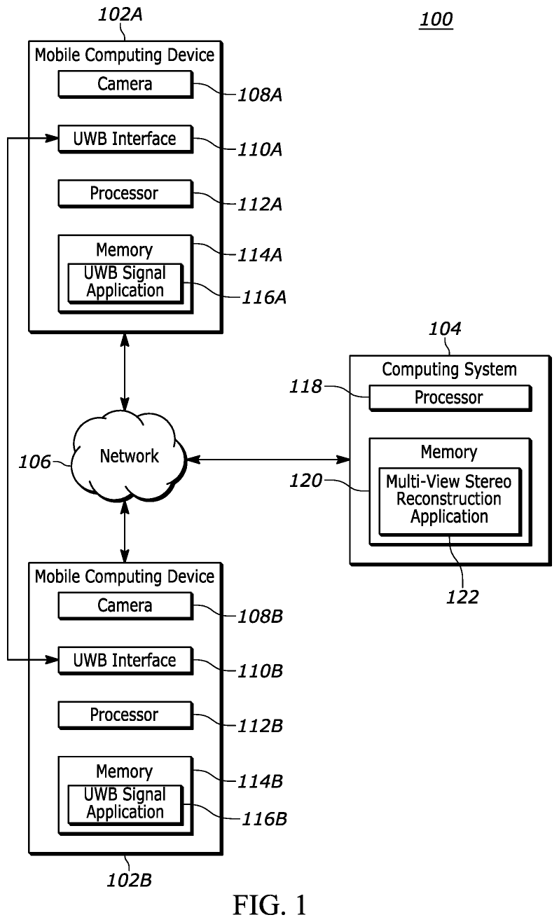

Referring now to the drawings, FIG. 1 depicts an exemplary computer system 100 for multi-view stereo reconstruction using ultra wideband (UWB) communication, according to one embodiment. The high-level architecture illustrated in FIG. 1 may include both hardware and software applications, as well as various data communications channels for communicating data between the various hardware and software components, as is described below.

The system 100 may include two or more mobile computing devices 102A, 102B (which may include, e.g., smart phones, smart watches or fitness tracker devices, tablets, laptops, virtual reality headsets, smart or augmented reality glasses, wearables, etc.), and a computing system 104. The mobile computing devices 102A, 102B may be configured to communicate with the computing system 104 via a wired or wireless computer network 106.

Although two mobile computing devices 102A, 102B, one computing system 104, and one network 106 are shown in FIG. 1, any number of such mobile computing devices 102A, 102B, computing systems 104, and networks 106 may be included in various embodiments. To facilitate such communications, the mobile computing devices 102A, 102B and the computing system 104 may each respectively comprise a wireless transceiver (not shown) to receive and transmit wireless communications via the network 106.

The mobile computing devices 102A, 102B may each include respective cameras 108A, 108B configured to capture digital images, e.g., two-dimensional images of three-dimensional objects. Furthermore, the mobile computing devices 102A, 102B may each include radio technology interfaces that are suitable for short-range, high-bandwidth communications over a large portion of a radio spectrum. For example, the mobile computing devices 102A, 102B may each include respective UWB interfaces 110A, 110B configured to exchange UWB signals between the mobile computing devices 102A, 102B. That is, the mobile computing device 102A may send UWB signals via the UWB interface 110A, and those signals may be received by the UWB interface 110B of the mobile computing device 102B. Similarly, the mobile computing device 102B may send UWB signals via the UWB interface 110B, and those signals may be received by the UWB interface 110A of the mobile computing device 102A.

Additionally, the mobile computing devices 102A, 102B may each include one or more respective processor(s) 112A, 112B, as well as one or more respective computer memories 114A, 114B. Memories 114A, 114B may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. Memorie(s) 114A, 114B may store an operating system (OS) capable of facilitating the functionalities, apps, methods, or other software as discussed herein. Memorie(s) 114A, 114B may also store respective UWB signal applications 116A, 116B.

For instance, executing the UWB signal application 116A may include causing the camera 108A to capture one or more two-dimensional images of a three-dimensional object and exchange UWB signals with one or more other mobile computing device(s) 102B that have also captured one or more two-dimensional images of the same three-dimensional object via the UWB interface 110A. In particular, executing the UWB signal application 116 may include exchanging UWB signals with the one or more other mobile computing device(s) 102B simultaneously (that is, at the exact time, or shortly before or after one another, i.e., within a threshold period of time such as one second, two seconds, five seconds, etc.) with the camera 108A capturing the two-dimensional images of the three-dimensional object, and simultaneously with the camera 108B capturing its own respective two-dimensional images of the three-dimensional object. Executing the UWB signal application 116A may further include determining the direction from which the UWB signals from the other mobile computing device(s) 102B arrived at the mobile computing device 102A, and the amount of time the UWB signals took to travel from the other mobile computing device(s) 102B to the mobile computing device 102A. Additionally, executing the UWB signal application 116A may include sending the captured one or more two-dimensional images of the three-dimensional object, as well as an indication of the direction from which the UWB signals from the other mobile computing device(s) 102B arrived at the mobile computing device 102A, and the amount of time the UWB signals took to travel from the other mobile computing device(s) 102B to the mobile computing device 102A, to the computing system 104 (e.g., via the network 106).

In some examples, executing the UWB signal application 116A may include determining the relative positions of the other mobile computing device(s) 102B with respect to the mobile computing device 102A based on the round trip time associated with “handshake” between the mobile computing device 102A and the mobile computing device 102B (i.e., the mobile computing device 102A sending an UWB signal to the mobile computing device 102B and the mobile computing device 102A subsequently receiving an UWB signal from the mobile computing device 102B), as discussed in further detail below. In other examples, executing the UWB signal application 116A may include sending an indication of this round trip time to the computing system 104, and the multi-view stereo reconstruction application 122 of the computing system 104 may in turn determine the relative positions of the other mobile computing device(s) 102B with respect to the mobile computing device 102A based on the round trip time.

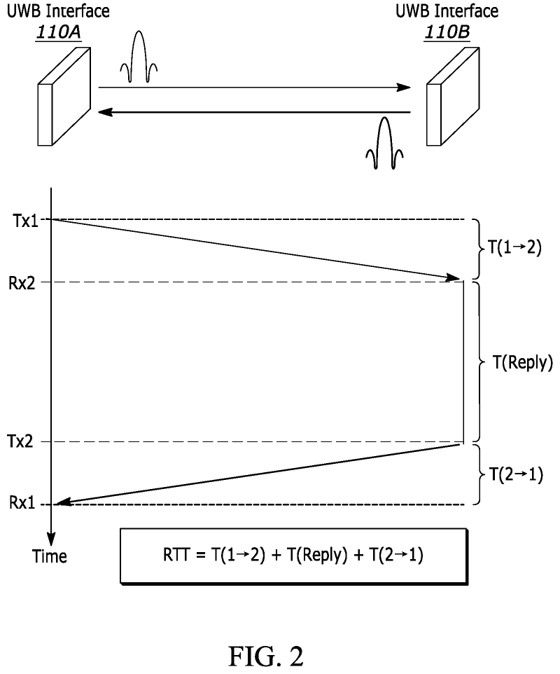

FIG. 2 illustrates an example “handshake” of UWB signals between the UWB interface 110A of the mobile computing device 102A and the UWB interface 110B of the mobile computing device 102B. As shown at FIG. 2, the UWB interface 110A of the mobile computing device 102A may send a first impulse signal to the UWB interface 110B of the mobile computing device 102B at time T×1. This first signal may take time T_{1→2} to travel from UWB interface 110A to UWB interface 110B, and the UWB interface 110B may receive the first signal at time R×2. The UWB interface 110B may already have a template for decoding the first impulse signal from UWB interface 110A, and may prepare a reply in a fixed, known amount of time T_{(reply)}. UWB interface 110B may then send a second impulse signal to UWB interface 110A at time T×2. This second signal may take time T_{2→1} to travel from UWB interface 110B to UWB interface 110A, and the UWB interface 110A may receive the second signal at time R×1. Executing the UWB signal application 116A may include determining the distance (d) between UWB interface 110A and UWB interface 110B based on the round trip time (RTT) using the following equations, where c is the speed of light:

$$R T T = {T}_{1 \to 2} + {T}_{( r e p l y )} + {T}_{2 \to 1}$$

$$d = \frac{c ( R T T - {T}_{( reply )} )}{2}$$

Furthermore, executing the UWB signal application 116A may include generating an UWB Euclidean distance matrix (UWB-EDM) for N total mobile computing devices 102A, 102B, as a data structure, where its (i, j)-th entry equals the squared distance from i-th to j-th node.

For ground truth geographic coordinates for the N total mobile computing devices 102A, 102B of T={(xₖ, yₖ): k=1, 2, . . . , N}, the UWB Euclidean distance matrix (UWB-EDM) may be defined as:

$$E D M ( T ) = [ \begin{matrix}0 & {d}_{1 , 2}^{2} & … & {d}_{1 , N}^{2} \\ ⋮ & & ⋱ & ⋮ \\ {d}_{N , 1}^{2} & {d}_{N , 2}^{2} & … & 0\end{matrix} ]$$

Generally speaking, the UWB-EDM is element-wise non-negative (because distance values are always non-negative), is zero diagonal (because distance from itself to itself is always zero) and is symmetric (because the distance from mobile computing device 102A to mobile computing device 102B is the same as the distance from mobile computing device 102B to mobile computing device 102A).

Executing the UWB signal application 116A may include estimating the relative topology of the UWB network using classic multidimensional scaling (MDS). Using EDM (T) as an input, the UWB signal application 116A may compute a geometric centering matrix using the following equation:

$$C = I - \frac{1}{n} 1 {1}^{T} ,$$

where I is an identity matrix of size n

The UWB signal application 116A may then compute a Gram matrix using the following equation:

$$G = - 0.5 C ( E D M ( T ) ) C$$

The UWB signal application 116A may perform an eigenvalue decomposition using the following equation:

U, [λᵢ]ᵢ₌₁ⁿ=EVD(G), where U is a unitary matrix and λ is an eigenvalue for i.

Finally, the UWB signal application 116A may estimate the relative topology of the UWB network using the following equation:

$${T}_{UWB} = [ diag ( \sqrt{{λ}_{1}} ) , … , \sqrt{{λ}_{d}} ) , {0}_{dx ( N - d )} ] {U}^{T}$$

Additionally, the UWB signal application 116A may determine relative poses of each of the mobile computing devices 102A, 102B with respect to one another based on a direction of arrival associated with UWB signals that are received by the mobile computing device 102A from the mobile computing device 102B. In other examples, executing the UWB signal application 116A may include sending an indication of the direction of arrival to the computing system 104, and the multi-view stereo reconstruction application 122 of the computing system 104 may in turn determine relative poses of each of the mobile computing devices 102A, 102B with respect to one another based on the direction of arrival associated with UWB signals that are received by the mobile computing device 102A from the mobile computing device 102B.

For instance, in some examples, the UWB interface 110A of the mobile computing device 102A may be equipped with multiple antennas located at different, known positions of the mobile computing device 102A. The direction of the mobile computing device 102B from the mobile computing device 102A may be determined based on receiving the UWB signal from the mobile computing device 102B at each of the multiple antennas of the UWB interface 110A of the mobile computing device 102A, i.e., based on the known position of each antenna and a time difference at which each of the antennas received the UWB signal from the mobile computing device 102B. In some implementations, the mobile computing device 102A may include a compass, magnetometer, gyroscope, accelerometer, and/or other sensors to determine its own orientation, and the direction of arrival of the UWB signal from the mobile computing device 102B may be determined based on a time difference at which each of the antennas of the UWB interface 110A received the UWB signal from the mobile computing device 102B, and based on the orientation of the mobile computing device 102A.

In particular, the poses of the mobile computing devices 102A, 102B with respect to one another may be indicative of the orientation of the mobile computing devices 102A, 102B, which may in turn indicate (and/or may be used to determine or calculate) the orientation of the respective cameras 108A, 108B with respect to the three-dimensional object.

The UWB signal application 116A may send an indication of the determined relative three-dimensional positions and poses of the mobile computing device(s) 102A, 102B with respect to one another and/or with respect to the three-dimensional object to the computing system 104 (e.g., via the network 106).

Generally speaking, the UWB signal application 116B of the mobile computing device 102B may be executed in a similar manner as the UWB signal application 116A discussed above with respect to the mobile computing device 102A, and additional UWB signal applications of additional mobile computing devices may be executed in a similar manner with respect to one another.

Turning now to the computing system 104, in some embodiments the computing system 104 may comprise one or more servers, which may comprise multiple, redundant, or replicated servers as part of a server farm. In still further aspects, such server(s) may be implemented as cloud-based servers, such as a cloud-based computing platform. For example, such server(s) may be any one or more cloud-based platform(s). Such server(s) may include one or more processor(s) 118 (e.g., CPUs) as well as one or more computer memories 120.

Memories 120 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. Memorie(s) 120 may store an operating system (OS) capable of facilitating the functionalities, apps, methods, or other software as discussed herein. Memorie(s) 120 may also store a multi-view stereo reconstruction application 122.

Executing the multi-view stereo reconstruction application 122 may include receiving (e.g., from the mobile computing devices 102A, 102B, via the network 106) two-dimensional images of a three-dimensional object captured by the respective cameras 108A, 108B of two or more mobile computing devices 102A, 102B. In particular, as discussed above, the images of the three-dimensional object may be captured by the respective cameras 108A, 108B of two or more mobile computing devices 102A, 102B substantially simultaneously with one another (that is, at the exact time, or shortly before or after one another, i.e., all images may be captured within a threshold period of time such as one second, two seconds, five seconds, etc.).

Moreover, executing the multi-view stereo reconstruction application 122 may include receiving an indication of the relative positions and poses of the mobile computing device(s) 102A, 102B with respect to one another, e.g., from one or more of the mobile computing device(s) 102A, 102B, or determining the relative positions and poses of the mobile computing device(s) 102A, 102B with respect to one another, as discussed above, based on receiving data from one or more of the mobile computing devices 102A, 102B.

Furthermore, executing the multi-view stereo reconstruction application 122 may include generating a three-dimensional image of the three-dimensional object based on the two-dimensional images of the three-dimensional object captured by the mobile computing devices 102A, 102B, and the relative positions and poses of the mobile computing devices 102A, 102B with respect to one another (i.e., including the orientations of the respective cameras 108A, 108B with respect to the three-dimensional object). That is, the multi-view stereo reconstruction application 122 may use any of a number known multi-view image reconstruction algorithms (e.g., space carving, neural radiance fields (NeRF), graph cuts, etc.) to stitch the two-dimensional images of the three-dimensional object captured by the mobile computing devices 102A, 102B into a three-dimensional image based on the relative positions and poses of the mobile computing devices 102A, 102B with respect to one another.

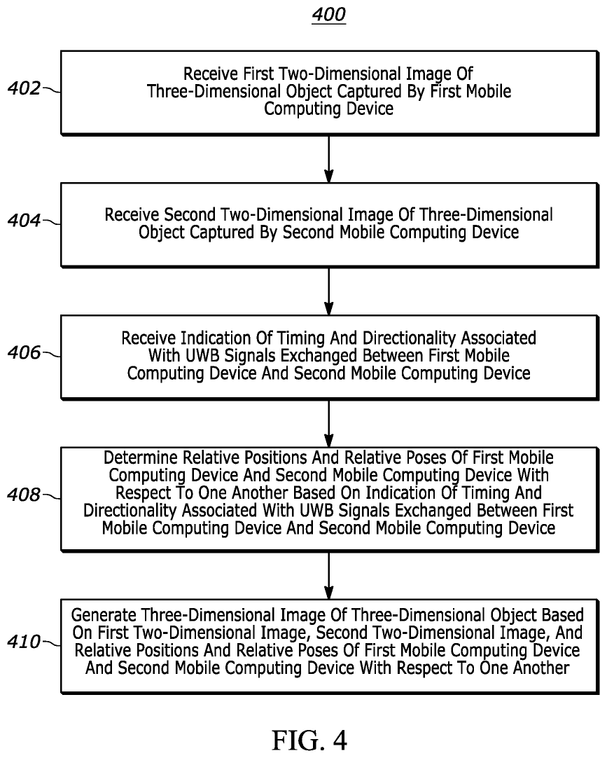

In addition, memories 120 may also store additional machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For instance, in some examples, the computer-readable instructions stored on the memory 120 may include instructions for carrying out any of the steps of the method 400 via an algorithm executing on the processors 118, which is described in greater detail below with respect to FIG. 4. It should be appreciated that one or more other applications may be envisioned and that are executed by the processor(s) 118. It should be appreciated that given the state of advancements of mobile computing devices, all of the processes functions and steps described herein may be present together on a mobile computing device.

### Example Mobile Computing Device Camera Positioning

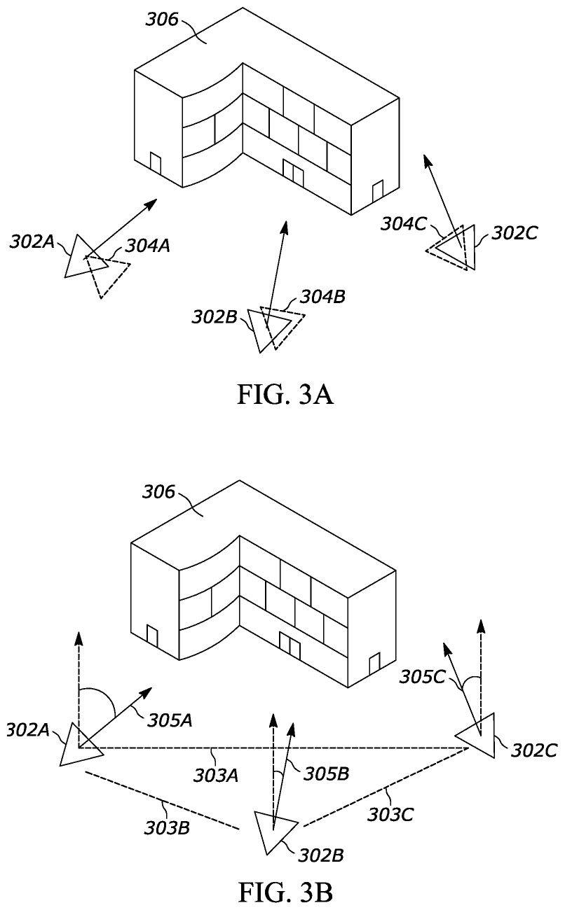

FIG. 3A depicts mobile computing device camera positions and directions with respect to a three-dimensional object, as may be estimated and re-estimated using conventional multi-view stereo reconstruction methods, compared to the actual camera positions and directions with respect to the three-dimensional object. For instance, mobile computing devices 302A, 302B, and 302C may be configured to capture two-dimensional images of a three-dimensional object 306 (e.g., a building). The positions of the mobile computing devices 302A, 302B, and 302C may be estimated using GPS, with an error of approximately 3 meters. For instance, FIG. 3A illustrates an estimated position of 304A for the mobile computing device 302A, an estimated position of 304B for the mobile computing device 302B, and an estimated position of 304C for the mobile computing device 302C. Using conventional multi-view stereo reconstruction methods, an initial three-dimensional image reconstruction of the three-dimensional object 306 is generated based on the images and the estimated positions 304A, 304B, and 304C of the mobile computing devices 302A, 302B, and 302C. Using conventional multi-view stereo reconstruction methods, errors in the initial three-dimensional image reconstruction of the three-dimensional object 306 are identified and used to attempt to correct the estimated positions 304A, 304B, and 304C of the mobile computing devices 302A, 302B, and 302C, and a new three-dimensional image of the three-dimensional object 306 is reconstructed based on the corrected positions. Using conventional multi-view stereo reconstruction methods, this process must then be repeated several times until a suitable three-dimensional image reconstruction of the three-dimensional object 306 can be generated.

FIG. 3B depicts example mobile computing camera positions and directions with respect to a three-dimensional object, as may be calculated accurately using UWB communication between the devices associated with the cameras, according to embodiments provided herein. As shown in FIG. 3B, mobile computing devices 302A, 302B, and 302C may be configured to capture two-dimensional images of a three-dimensional object 306.

However, rather than using GPS to estimate the positions of the mobile computing devices 302A, 302B, and 302C (as discussed above with respect to FIG. 3A), the positions of the mobile computing devices 302A, 302B, and 302C are estimated based on UWB signals 303A, 303B, and 303C exchanged between the mobile computing devices 302A, 302B, and 302C, as discussed above with respect to FIGS. 1 and 2. The positions of the mobile computing devices 302A, 302B, and 302C, as estimated based on UWB signals 303A, 303B, and 303C exchanged between the mobile computing devices 302A, 302B, and 302C, will have an error of approximately 10 cm. Furthermore, the relative poses 305A, 305B, 305C of the mobile computing devices with respect to one another (and/or with respect to the three-dimensional object 306) are also estimated based on UWB signals 303A, 303B, and 303C exchanged between the mobile computing devices 302A, 302B, and 302C, as discussed above with respect to FIGS. 1 and 2. A three-dimensional image of the three-dimensional object 306 may then be generated based on the images captured by the mobile computing devices 302A, 302B, and 302C, and the relative positions and poses 305A, 305B, and 305C of the mobile computing devices 302A, 302B, and 302C that are estimated based on UWB signals 303A, 303B, and 303C exchanged between the mobile computing devices 302A, 302B, and 302C.

Advantageously, using the techniques provided herein, after the relative positions and poses 305A, 305B, and 305C of the mobile computing devices 302A, 302B, and 302C are estimated based on UWB signals 303A, 303B, and 303C exchanged between the mobile computing devices 302A, 302B, and 302C, the three-dimensional image of the three-dimensional object 306 is generated just once, in contrast to the conventional methods discussed with respect to FIG. 3A in which multiple three-dimensional images of the three-dimensional object 306 must be generated iteratively, resulting in both increased efficiency and increased accuracy compared to conventional methods.

### Example Method

FIG. 4 depicts a flow diagram of an exemplary computer-implemented method 400 for multi-view stereo reconstruction using ultra wideband (UWB) communication, according to one embodiment. One or more steps of the method 400 may be implemented as a set of instructions stored on a computer-readable memory (e.g., memory 114A, memory 114B, memory 120, etc.) and executable on one or more processors (e.g., processor 112A, processor 112B, processors 118, etc.).

The method 400 may include receiving a first two-dimensional image of a three-dimensional object captured by a first mobile computing device (block 402).

Additionally, the method 400 may include receiving a second two-dimensional image of the three-dimensional object captured by a second mobile computing device (block 404). For instance, the first mobile computing device and the second mobile computing device may be within a threshold distance of one another (e.g., a distance of 100 m).

In some examples, the first two-dimensional image and the second two-dimensional image may both be captured within a threshold amount of time, and the UWB signals may be exchanged between the first mobile computing device and second mobile computing device, within the same threshold amount of time.

Furthermore, the method 400 may include receiving an indication of timing and directionality associated with UWB signals exchanged between the first mobile computing device and the second mobile computing device (block 406).

For instance, the indication of timing associated with the UWB signals exchanged between the first mobile computing device and the second mobile computing device may be an indication of a round trip time, e.g., from a time that the first mobile computing device sends a first UWB signal to the second mobile computing device to a time that the first mobile computing device receives a second UWB signal from the second mobile computing device, and/or a round trip time from a time that the second mobile computing device sends a first UWB signal to the first mobile computing device to a time that the second mobile computing device receives a second UWB signal from the first mobile computing device.

Furthermore, the indication of directionality associated with the UWB signals exchanged between the first mobile computing device and the second mobile computing device may be, for instance, an indication of a direction of arrival associated with a UWB signal that the first mobile computing device receives from the second mobile computing device, and/or an indication of a direction of arrival associated with a UWB signal that the second mobile computing device receives from the first mobile computing device.

Moreover, the method 400 may include determining relative positions and relative poses of the first mobile computing device and the second mobile computing device with respect to one another based on the indication of the timing and directionality associated with the UWB signals exchanged between the first mobile computing device and the second mobile computing device (block 408).

The method 400 may then include generating a three-dimensional image of the three-dimensional object based on the first two-dimensional image, the second two-dimensional image, and the relative positions and relative poses of the first mobile computing device and the second mobile computing device with respect to one another (block 410).

Additionally, in some examples, the method 400 may further include receiving a third two-dimensional image of the three-dimensional object, captured by a third mobile computing device, and receiving an indication of the timing and directionality associated with the UWB signals exchanged between the third mobile computing device and the first mobile computing device and/or second mobile computing device.

For instance, the first two-dimensional image, the second two-dimensional image, and the third two-dimensional image may be captured within a threshold amount of time, and the UWB signals may be exchanged between the first mobile computing device, second mobile computing device, and/or third mobile computing device within the same threshold amount of time.

The method 400 may include determining relative positions and relative poses of the third mobile computing device and the one or more of the first mobile computing device or the second mobile computing device with respect to one another based on the indication of the timing and directionality associated with the UWB signals exchanged between the third mobile computing device and one or more of the first mobile computing device or the second mobile computing device. For instance, in such examples, generating the three-dimensional image of the three-dimensional object (e.g., as discussed with respect to block 410) may be further based on the third two-dimensional image and the relative positions and relative poses of the third mobile computing device and the first mobile computing device and/or second mobile computing device. That is, generating the three-dimensional image of the three-dimensional object may be based on the first two-dimensional image, the second two-dimensional image, the third two-dimensional image, and the relative positions and relative poses of the first mobile computing device, the second mobile computing device, and/or third computing device with respect to one another.

In a similar manner, the method 400 may include receiving fourth, fifth, or any number of two-dimensional images of the three-dimensional object captured by respective fourth, fifth, etc., mobile computing devices, and receiving indications of the timing and directionality associated with UWB signals exchanged between the devices, and may generate the three-dimensional image of the three-dimensional object based on the two-dimensional images captured by each of the devices and their relative positions and poses with respect to one another.

### Additional Considerations

The following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” or “some embodiments” means that a particular element, feature, structure, or characteristic described in connection with the embodiment is included in at least one embodiment. The appearances of the phrase “in one embodiment” or “in some embodiments” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for multi-view stereo reconstruction using ultra wideband (UWB) communication. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A system for multi-view stereo reconstruction using ultra wideband (UWB) communication, comprising one or more processors and a memory storing instructions that, when executed by the one or more processors, cause the one or more processors to:
receive a first two-dimensional image of a three-dimensional object captured by a first mobile computing device;
receive a second two-dimensional image of the three-dimensional object captured by a second mobile computing device;
receive an indication of timing and directionality associated with UWB signals exchanged between the first mobile computing device and the second mobile computing device;
determine relative positions and relative poses of the first mobile computing device and the second mobile computing device with respect to one another based on the indication of the timing and directionality associated with the UWB signals exchanged between the first mobile computing device and the second mobile computing device; and
generate a three-dimensional image of the three-dimensional object based on the first two-dimensional image, the second two-dimensional image, and the relative positions and relative poses of the first mobile computing device and the second mobile computing device with respect to one another.

2. The system of claim 1, wherein the indication of timing associated with the UWB signals exchanged between the first mobile computing device and the second mobile computing device is an indication of a round trip time from a time that the first mobile computing device sends a first UWB signal to the second mobile computing device to a time that the first mobile computing device receives a second UWB signal from the second mobile computing device.

3. The system of claim 1 or 2, wherein the indication of directionality associated with the UWB signals exchanged between the first mobile computing device and the second mobile computing device is an indication of a direction of arrival associated with a UWB signal that the first mobile computing device receives from the second mobile computing device.

4. The system of claim 1, wherein the first two-dimensional image and the second two-dimensional image are captured, and the UWB signals are exchanged between the first mobile computing device and second mobile computing device, within a threshold amount of time.

5. The system of claim 1, wherein the instructions, when executed by the one or more processors, further cause the one or more processors to:
receive a third two-dimensional image of the three-dimensional object captured by a third mobile computing device;
receive an indication of timing and directionality associated with UWB signals exchanged between the third mobile computing device and one or more of the first mobile computing device or the second mobile computing device; and
determine relative positions and relative poses of the third mobile computing device and the one or more of the first mobile computing device or the second mobile computing device with respect to one another based on the indication of the timing and directionality associated with the UWB signals exchanged between the third mobile computing device and one or more of the first mobile computing device or the second mobile computing device;
wherein generating the three-dimensional image is further based on the third two-dimensional image and the relative positions and relative poses of the third mobile computing device and the one or more of the first mobile computing device or the second mobile computing device with respect to one another.

6. The system of claim 5, wherein the first two-dimensional image, the second two-dimensional image, and the third two-dimensional image are captured, the UWB signals are exchanged between the first mobile computing device and second mobile computing device, and the UWB signals are exchanged between the third mobile computing device and the one or more of the first mobile computing device or the second mobile computing device, within a threshold amount of time.

7. The system of claim 1, wherein the first mobile computing device and the second mobile computing device are within a threshold distance of one another.

8. A computer-readable medium storing instructions for multi-view stereo reconstruction using ultra wideband (UWB) communication that, when executed by one or more processors, cause the one or more processors to:
receive a first two-dimensional image of a three-dimensional object captured by a first mobile computing device;
receive a second two-dimensional image of the three-dimensional object captured by a second mobile computing device;
receive an indication of timing and directionality associated with UWB signals exchanged between the first mobile computing device and the second mobile computing device;
determine relative positions and relative poses of the first mobile computing device and the second mobile computing device with respect to one another based on the indication of the timing and directionality associated with the UWB signals exchanged between the first mobile computing device and the second mobile computing device; and
generate a three-dimensional image of the three-dimensional object based on the first two-dimensional image, the second two-dimensional image, and the relative positions and relative poses of the first mobile computing device and the second mobile computing device with respect to one another.

9. The computer-readable medium of claim 8, wherein the indication of timing associated with the UWB signals exchanged between the first mobile computing device and the second mobile computing device is an indication of a round trip time from a time that the first mobile computing device sends a first UWB signal to the second mobile computing device to a time that the first mobile computing device receives a second UWB signal from the second mobile computing device.

10. The computer-readable medium of claim 8, wherein the indication of directionality associated with the UWB signals exchanged between the first mobile computing device and the second mobile computing device is an indication of a direction of arrival associated with a signal UWB that the first mobile computing device receives from the second mobile computing device.

11. The computer-readable medium of claim 8, wherein the first two-dimensional image and the second two-dimensional image are captured, and the UWB signals are exchanged between the first mobile computing device and second mobile computing device, within a threshold amount of time.

12. The computer-readable medium of claim 8, wherein the instructions, when executed by the one or more processors, further cause the one or more processors to:
receive a third two-dimensional image of the three-dimensional object captured by a third mobile computing device;
receive an indication of timing and directionality associated with UWB signals exchanged between the third mobile computing device and one or more of the first mobile computing device or the second mobile computing device; and
determine relative positions and relative poses of the third mobile computing device and the one or more of the first mobile computing device or the second mobile computing device with respect to one another based on the indication of the timing and directionality associated with the UWB signals exchanged between the third mobile computing device and one or more of the first mobile computing device or the second mobile computing device;
wherein generating the three-dimensional image is further based on the third two-dimensional image and the relative positions and relative poses of the third mobile computing device and the one or more of the first mobile computing device or the second mobile computing device with respect to one another.

13. The computer-readable medium of claim 12, wherein the first two-dimensional image, the second two-dimensional image, and the third two-dimensional image are captured, the UWB signals are exchanged between the first mobile computing device and second mobile computing device, and the UWB signals are exchanged between the third mobile computing device and the one or more of the first mobile computing device or the second mobile computing device, within a threshold amount of time.

14. The computer-readable medium of claim 8, wherein the first mobile computing device and the second mobile computing device are within a threshold distance of one another.

15. A computer-implemented method for multi-view stereo reconstruction using ultra wideband (UWB) communication, comprising:
receiving, by one or more processors, a first two-dimensional image of a three-dimensional object captured by a first mobile computing device;
receiving, by the one or more processors, a second two-dimensional image of the three-dimensional object captured by a second mobile computing device;
receiving, by one or more processors, an indication of timing and directionality associated with UWB signals exchanged between the first mobile computing device and the second mobile computing device;
determining, by the one or more processors, relative positions and relative poses of the first mobile computing device and the second mobile computing device with respect to one another based on the indication of the timing and directionality associated with the UWB signals exchanged between the first mobile computing device and the second mobile computing device; and
generating, by the one or more processors, a three-dimensional image of the three-dimensional object based on the first two-dimensional image, the second two-dimensional image, and the relative positions and relative poses of the first mobile computing device and the second mobile computing device with respect to one another.

16. The method of claim 15, wherein the indication of timing associated with the UWB signals exchanged between the first mobile computing device and the second mobile computing device is an indication of a round trip time from a time that the first mobile computing device sends a first UWB signal to the second mobile computing device to a time that the first mobile computing device receives a second UWB signal from the second mobile computing device.

17. The method of claim 15, wherein the indication of directionality associated with the UWB signals exchanged between the first mobile computing device and the second mobile computing device is an indication of a direction of arrival associated with a signal UWB that the first mobile computing device receives from the second mobile computing device.

18. The method of claim 15, wherein the first two-dimensional image and the second two-dimensional image are captured, and the UWB signals are exchanged between the first mobile computing device and second mobile computing device, within a threshold amount of time.

19. The method of claim 15, further comprising:
receive a third two-dimensional image of the three-dimensional object captured by a third mobile computing device;
receiving, by one or more processors, an indication of timing and directionality associated with UWB signals exchanged between the third mobile computing device and one or more of the first mobile computing device or the second mobile computing device; and
determining, by the one or more processors, relative positions and relative poses of the third mobile computing device and the one or more of the first mobile computing device or the second mobile computing device with respect to one another based on the indication of the timing and directionality associated with the UWB signals exchanged between the third mobile computing device and one or more of the first mobile computing device or the second mobile computing device;
wherein generating the three-dimensional image is further based on the third two-dimensional image and the relative positions and relative poses of the third mobile computing device and the one or more of the first mobile computing device or the second mobile computing device with respect to one another.

20. The method of claim 19, wherein the first two-dimensional image, the second two-dimensional image, and the third two-dimensional image are captured, the UWB signals are exchanged between the first mobile computing device and second mobile computing device, and the UWB signals are exchanged between the third mobile computing device and the one or more of the first mobile computing device or the second mobile computing device, within a threshold amount of time.
